(19) United States
(12) Patent Application Publication
(10) Pub. No.: US 2010/0302330 A1
(43) Pub. Date: Dec. 2, 2010

(54) IMAGE FORMATION METHOD AND ACTIVE ENERGY BEAM-CURABLE INK

(75) Inventors: Shunsuke UOZUMI, Ibaraki-ken (JP); Kazuhiro HIGASHI, Ibaraki-ken (JP); Masami SHINOZAKI, Ibaraki-ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/757,346

(22) Filed: Apr. 9, 2010

(30) Foreign Application Priority Data
May 28, 2009 (JP) P2009-128583

(51) Int. Cl. B41J 2/01

(52) U.S. Cl. 347/102

(57) ABSTRACT

Disclosed is an image formation method comprising: using an inkjet recording method and an active energy beam-curable ink to form, on a permeable substrate having an ink image formed thereon, an image that corresponds with the ink image and is superimposed on top of the ink image.

### CROSS REFERENCE TO RELATED APPLICATIONS

This application is based upon and claims the benefit of priority from prior Japanese Patent Application No. 2009-128583 filed on May 28, 2009; the entire contents of which are incorporated by reference herein.

### BACKGROUND OF THE INVENTION

1. Field of the Invention

The present invention relates to an image formation method and an active energy beam-curable ink used in the method.

2. Description of the Related Art

When printing an ink image onto a permeable substrate such as a high-quality paper, the quick-drying properties of the ink printed on the substrate can be problematic. If the drying of the ink on the substrate is slow, then the ink may adhere to a transport roller or the like inside the printing apparatus. This causes soiling of the roller, and this roller soiling may then be transferred to the next substrate transported through the apparatus. Moreover, if this ink adhered to the roller solidifies and develops tackiness, then the ink may cause a substrate to bond to the roller, resulting in a paper jam. Furthermore, following printing of an ink image, if the substrate is rubbed through application of pressure or the like to the substrate surface, then the ink image may blur or broaden. In order to address these issues, a protective layer may be formed on the surface of the ink image following printing of the image onto the substrate, thereby improving the quick-drying properties and the abrasion resistance of the substrate surface.

Active energy beam-curable inks, which use a compound that polymerizes upon irradiation with an active energy beam such as an ultraviolet light beam as a vehicle, exhibit excellent quick-drying properties, and do not require a heated drying step. Furthermore, because these inks are solventless, they also offer the advantages of causing no environmental contamination and having a high degree of safety. As a result, these inks are sometimes used as protective layers for ink images.

Patent Document 1 (Japanese Patent Laid-Open No. 2008-201893) discloses a method of producing a glossy printed item that comprises using an in-line method to apply a specific ultraviolet-curable overprint varnish composition to the surface of a paper such as a coated paper having an oil-based ink printed thereon, and subsequently curing the composition. It is stated that by using this overcoat varnish composition, a smooth continuous coating can be formed without being repelled by the oil-based ink printed surface, even if the applied coating is very thin, and a printed item can be obtained that exhibits favorable abrasion resistance and anti-blocking properties as well as a high degree of gloss. This overprint varnish composition is applied using a roll coater or chamber coater or the like.

However, controlling the coating quantity is difficult using a roll coater or the like, meaning applying a small amount of the overprint varnish composition in a uniform manner is problematic. Further, in the case of a permeable substrate such as a high-quality paper, the overprint varnish composition penetrates onto the interior of the substrate, which can cause a phenomenon known as “show-through” in which the image can be seen from the underside of the substrate. Moreover, the apparatus used tends to be large and complex.

Show-through is a phenomenon in which the colorant in the ink does not penetrate through and exude from the underside of the substrate, but rather the solvent within the ink penetrates through and exudes from the underside of the substrate, meaning that when the substrate is viewed from the underside, the colorant on the printed surface or within the interior of the substrate is visible through the substrate. In a normal printed item, the show-through disappears when the residual solvent volatilizes, but in the case of the above type of ultraviolet-curable overprint varnish composition that cures on top of the substrate, the residual solvent does not volatilize, but is rather retained upon curing, meaning the show-through may be retained permanently.

Patent Document 2 (Japanese Patent Laid-Open No. 2002-144551) describes a problem in inkjet recording methods wherein when text characters or an image is recorded on a high-gloss inkjet recording medium using a water-based (aqueous) pigment ink, irregularities occur in the gloss level, and in order to address this problem, proposes a method of reducing gloss irregularity by discharging a specific amount of an overcoat liquid comprising a transparent polymer and water onto those portions that have been recorded with the water-based pigment ink.

However, a coated paper is used as the high-gloss inkjet recording medium, and because the overcoat liquid for such a coated paper is designed for the purposes of improving the gloss and the weather resistance of the printed surface, it differs from a coating liquid designed for use with a permeable substrate.

On the other hand, when printing is conducted onto a permeable substrate, the image density of the ink image can also be a problem. Particularly in those cases where an oil-based ink is used to perform printing onto a permeable substrate, the colorant may be drawn into the interior of the substrate together with the solvent within the oil-based ink, causing a reduction in the surface density of the image. Moreover, in the case of an oil-based ink, the colorant may penetrate right through to the underside of the substrate, causing the phenomenon known as “strike-through”, wherein the image is visible from the underside of the substrate.

### SUMMARY OF THE INVENTION

An object of the present invention is to provide an image formation method that yields superior image density and excellent abrasion resistance, and an active energy beam-curable ink that is used in such a method.

One aspect of the present invention provides an image formation method comprising: using an inkjet recording method and an active energy beam-curable ink to form, on a permeable substrate having an ink image formed thereon, an image that corresponds with the ink image and is superimposed on top of the ink image.

Another aspect of the present invention provides an active energy beam-curable ink that can be used in the above image formation method, wherein the ink has a refractive index prior to curing of not less than 1.480.

### DETAILED DESCRIPTION OF THE EMBODIMENTS

A description of embodiments according to the present invention is presented below, but the examples within these embodiments in no way limit the scope of the present invention.

The image formation method of the present invention comprises using an inkjet recording method and an active energy beam-curable ink to form, on a permeable substrate having an ink image formed thereon, an image that corresponds with the ink image and is superimposed on top of the ink image. By employing this type of image formation method and an active energy beam-curable ink used in the method, a printed item having superior image density and excellent abrasion resistance can be obtained.

When an active energy beam-curable ink is applied to a permeable substrate, the active energy beam-curable ink can sometimes penetrate into the interior of the permeable substrate, and therefore it is important that the coating quantity of the active energy beam-curable ink is controlled.

Accordingly, by using an inkjet recording method, the coating quantity of the active energy beam-curable ink can be appropriately controlled. An inkjet recording method is a printing method in which a liquid ink with a high degree of fluidity is sprayed from very fine nozzles and adhered to the substrate, and is a method that enables the printing of high-resolution, high-quality images at high speed and with minimal noise using a comparatively inexpensive printing apparatus.

By using an inkjet recording method, an active energy beam-curable ink can be applied in the form of an image that corresponds with an ink image, so as to be appropriately superimposed on top of the ink image. As a result, the ink image can be protected, while suppressing the amount of the active energy beam-curable ink applied directly to the permeable substrate to a very small amount.

By employing this type of image formation method, the ink image is protected by the active energy beam-curable ink, meaning a printed item can be obtained which not only displays excellent quick-drying properties, but also exhibits superior image density and excellent abrasion resistance.

Because the ink image is covered with the active energy beam-curable ink, it is thought that the active energy beam-curable ink acts as a type of lens, thereby increasing the image density of the ink image. Further, even if the coating quantity of the active energy beam-curable ink protecting the ink image is relatively small, because the inkjet recording method can be used to appropriately control the coating quantity and the coating region, satisfactory abrasion resistance can still be achieved.

Furthermore, because the inkjet recording method can be used to control the volume of liquid droplets of the active energy beam-curable ink, penetration of the active energy beam-curable ink into the interior of the substrate can be suppressed, meaning show-through can be prevented. Moreover, deterioration in the image density caused by the colorant of the ink image being drawn into the interior of the substrate together with the active energy beam-curable ink can also be prevented.

In this description, the term “permeable substrate” describes a substrate in which the ash content within the base paper and the pigment coating layer is not less than 4% by mass and not more than 30% by mass for the combination of the ash content derived from the base paper and the ash content derived from the pigment coating layer, and in which the laser surface roughness is not less than 3.10 μm and the grammage is not less than 40 g/m² and not more than 90 g/m².

Examples of the permeable substrate include uncoated printing papers (such as high-quality papers, medium-quality papers, rough papers and tissue papers), lightweight coated papers, and communication papers. Specific examples of commercially available products that can be used favorably include uncoated printing papers (such as Riso lightweight paper (manufactured by Riso Kagaku Corporation) and New NPI high-quality paper (manufactured by Nippon Paper Group, Inc.)), lightweight coated papers (such as Pirene DX (manufactured by Nippon Paper Group, Inc.)), and communication papers (such as Multipaper Super Economy (manufactured by Askul Corporation) and Lightweight Full Color PPC paper type 6000 (manufactured by Ricoh Co., Ltd.)).

There are no particular limitations on the ink image, which may be an image formed using any arbitrary ink. The ink may be either oil-based or water-based, and may be either a pigment-based ink or a dye-based ink. Further, there are no particular restrictions on the recording method used for forming the ink image, and an arbitrary recording method such as an inkjet recording method, stencil printing method or electrophotographic method may be used. The ink used for forming the ink image may use an ink suited to the recording method employed.

The image formation method of the present invention yields a favorable effect on ink images formed using all manner of inks, and is particularly effective on ink images formed using an inkjet oil-based inks.

With inkjet oil-based inks, a problem arises in that the colorant such as a pigment tends to be drawn into the substrate interior together with the solvent, resulting in reduced image density. In order to address this problem, the image formation method of the present invention is able to increase the image density. Further, inkjet oil-based inks also suffer from the problem of strike-through, where the ink penetrates right through the substrate to the opposite side from the printed surface, but by employing the image formation method of the present invention, because the amount of the active energy beam-curable ink can be restricted to a small amount, any penetration of the inkjet oil-based ink into the substrate interior together with the active energy beam-curable ink is suppressed, enabling strike-through of the inkjet oil-based ink to the underside of the substrate to be prevented.

An ink comprising a colorant and a solvent can be used as the inkjet oil-based ink.

Examples of the colorant within the inkjet oil-based ink include pigments, dyes, and mixtures thereof. Examples of pigments that can be used favorably include organic pigments such as azo-based pigments, phthalocyanine-based pigments, dye-based pigments, condensed polycyclic pigments, nitro-based pigments and nitroso-based pigments (such as carmine 6B, lake red, disazo yellow, phthalocyanine blue, aniline black, alkali blue and quinacridone); inorganic pigments, including metals such as cobalt, chromium, copper, zinc, lead, titanium, vanadium, manganese and nickel, metal oxides and sulfides, and yellow ocher, ultramarine and iron blue pigments; as well as carbon black, titanium oxide, and zinc oxide. Further, examples of dyes that can be used include oil-soluble dyes such as azo-based dyes, anthraquinone-based dyes and azine-based dyes. Either a pigment or a dye may be used as the colorant, but using a pigment yields an ink that also exhibits excellent light resistance. The amount of the colorant relative to the total mass of the inkjet oil-based ink is preferably within a range from 0.1 to 50% by mass, and is more preferably from 1 to 30% by mass.

The solvent for the inkjet oil-based ink (or the oil-based solvent) may be selected appropriately from amongst polar organic solvents and non-polar organic solvents. From the viewpoint of safety, solvents having a 50% distillation point of at least 160° C., and particularly 230° C. or higher, are preferred. The “50% distillation point” is measured in accordance with JIS K0066 “Test Methods for Distillation of Chemical Products” and is defined as the temperature at which 50% of the weight of the solvent has volatilized.

Specific examples of the solvent include ester-based solvents having 14 or more carbon atoms within each molecule, such as methyl oleate, ethyl oleate, isopropyl oleate, butyl oleate, methyl linoleate, isobutyl linoleate, ethyl linoleate, methyl soybean oil, isobutyl soybean oil and isopropyl isostearate, alcohol-based solvents having 12 or more carbon atoms within each molecule, such as isomyristyl alcohol, isopalmityl alcohol, isostearyl alcohol, isoeicosyl alcohol, isohexacosanol and castor oil, aliphatic hydrocarbon solvents including the commercially available products Teclean N-16, Teclean N-20, Teclean N-22, Nisseki Naphtesol L, Nisseki Naphtesol M, Nisseki Naphtesol H, No. 0 Solvent L, No. 0 Solvent M, No. 0 Solvent H, Nisseki Isosol 300, Nisseki Isosol 400, AF-4, AF-5, AF-6 and AF-7 (all product names manufactured by Nippon Oil Corporation) and Isopar G, Isopar H, Isopar L, Isopar M, Exxsol D40, Exxsol D80, Exxsol D100, Exxsol D130 and Exxsol D140 (all product names manufactured by Exxon Mobil Corporation), and aromatic hydrocarbon solvents such as Nisseki Cleansol G (alkylbenzene) (a product name, manufactured by Nippon Oil Corporation). These solvents may be used individually, or in combinations containing two or more solvents.

Besides the components described above, the inkjet oil-based ink may also include suitable amounts of additive components including pigment dispersants, antioxidants, antibacterial agents, moldproofing agents, polymerization inhibitors and pH modifiers.

There are no particular restrictions on the method used for preparing the inkjet oil-based ink, and conventional methods may be used.

The viscosity of the inkjet oil-based ink may be altered as appropriate, but from the viewpoint of achieving favorable discharge properties at the inkjet head, is preferably within a range from 5 to 100 mPa·s. This viscosity is measured at 25° C. by raising the shear stress from 0 Pa at a rate of 0.1 Pals, and refers to the ink viscosity at 10 Pa.

Specific examples of commercially available inkjet oil-based inks that can be used favorably include the HC inks (inkjet oil-based inks, manufactured by Riso Kagaku Corporation). The main components of these HC inks are petroleum-based hydrocarbons, higher alcohols, fatty acid esters, pigments and polymer dispersants.

The ink image may also be formed with all manner of other inks besides the inkjet oil-based inks described above. For example, the ink image may be formed using an inkjet water-based ink, a stencil printing water-based ink, an oil-based ink or an emulsion ink. With these ink images, the image density can be increased and the abrasion resistance improved in the same manner as described above.

The active energy beam-curable ink of the present invention comprises an active energy beam-curable resin (or an active energy beam-polymerizable component) as the main component, and from the viewpoint of visibility of the ink image, is preferably either transparent or semi-transparent. The terms “transparent” and “semi-transparent” include not only colorless inks, but also colored transparent and semi-transparent inks.

Examples of the active energy beam-curable resin include radical polymerizable resin compositions and cationic polymerizable resin compositions. Of these, a cationic polymerizable resin composition is preferred in terms of the adhesion between the substrate and the ink image, but a radical polymerizable resin composition is preferred from the viewpoints of the curing rate and the raw material costs. A radical polymerizable resin composition is ideal in those cases where faster process speeds and improved process efficiency are required.

From the viewpoint of the ink viscosity, the amount of the active energy beam-curable resin relative to the total mass of the active energy beam-curable ink, is preferably within a range from 60 to 95% by mass, and is more preferably from 80 to 95% by mass.

Examples of the polymerizable resin component within a radical polymerizable resin composition include oligomers and monomers of (meth)acrylic acid-modified derivatives of all manner of compounds such as urethane-based, epoxy-based, polyester-based and polyol-based compounds, as well as oligomers and monomers of unsaturated polyester compounds and aromatic vinyl compounds.

Specific examples of the above oligomers include epoxy acrylates, epoxidized oil acrylates, urethane acrylates, polyether acrylates, vinyl acrylates and polyester acrylates.

The monomers mentioned above include both monofunctional acrylates and polyfunctional acrylates. Specific examples of the monofunctional acrylates include dicyclopentenyloxyethyl acrylate, isobornyl acrylate, phenol ethylene oxide-modified acrylate and fluorene diacrylate. Specific examples of the polyfunctional acrylates include tripropylene glycol diacrylate, 1,9-nonanediol diacrylate, 1,6-hexanediol diacrylate, bisphenol A diglycidyl ether diacrylate, tetraethylene glycol diacrylate, trimethylolpropane triacrylate, pentaerythritol triacrylate, pentaerythritol tetraacrylate, dipentaerythritol hexaacrylate, N-acryloyloxyethyl hexahydrophthalimide, dimethyloldicyclopentane diacrylate and isocyanuric acid EO-modified diacrylate (wherein “EO-modified” means ethylene oxide-modified).

Any one of these monomers or oligomers may be used individually, or two or more may be used in combination. The active energy beam-curable ink is printed using an inkjet recording method, and therefore from the viewpoint of the ink viscosity, a monomer is preferably the main component of the polymerizable resin component.

A photoinitiator is usually added to the radical polymerizable resin composition. There are no particular restrictions on the photoinitiator, and conventional materials may be used, including Irgacure 819, Irgacure 184, Darocure 1173, Irgacure 907 and Irgacure 369 (all manufactured by Ciba Japan K.K.), Kayacure DETX-S and Kayacure ITX (both manufactured by Nippon Kayaku Co., Ltd.), Lucirin TPO (manufactured by BASF Corporation), benzophenone, acetophenone, 4,4′-bisdiethylaminobenzophenone, benzil, benzoin and benzoin ethyl ether. Any of these photoinitiators may be used individually, or two or more may be used in combination.

The photoinitiator is typically added in an amount within a range from 1 to 20% by mass relative to the total mass of the active energy beam-curable ink. When an active energy beam-curable ink with a high degree of transparency is to be prepared, a photoinitiator must be selected that does not undergo yellowing upon irradiation with the active energy beam.

If required, a sensitizer may also be added to the radical polymerizable resin composition. Examples of the sensitizer include aliphatic amines such as n-butylamine, triethylamine and ethyl p-dimethylaminobenzoate, and aromatic amines. Any of these sensitizers may be used individually, or two or more may be used in combination. Commercially available sensitizers such as Kayacure DETX-S and EPA (both manufactured by Nippon Kayaku Co., Ltd.) may also be used. The sensitizer is typically added in an amount within a range from 0.1 to 10% by mass relative to the total mass of the ink.

Examples of the polymerizable resin component within a cationic polymerizable resin composition include cationic polymerizable vinyl compounds, cyclic lactones and cyclic ethers. Examples of the cationic polymerizable vinyl compounds include styrenes and vinyl ethers. Examples of the cyclic ether compounds include not only epoxy compounds and oxetane compounds, but also spiro ortho esters, bicyclo ortho esters, cyclic carbonates and Spiro ortho carbonates.

The term “epoxy compound” describes compounds having an oxirane group, which is a 3-membered ring represented by a formula (1) shown below, and includes aromatic epoxy compounds and alicyclic epoxy compounds and the like.

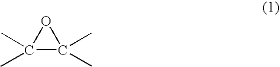

The term “oxetane compound” describes compounds having an oxetane ring, which is a 4-membered cyclic ether represented by a formula (2) shown below.

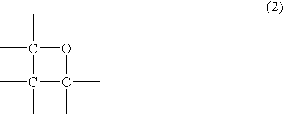

Preferred cationic polymerizable compounds include cyclic ethers which undergo a ring-opening polymerization in the presence of a cation, and alicyclic epoxy compounds and oxetane compounds are particularly preferred. Moreover, using a mixture of an alicyclic epoxy compound and an oxetane compound is particularly desirable as it provides excellent levels of both reactivity and curability. In such a case, the mixing ratio between the alicyclic epoxy compound and the oxetane compound (alicyclic epoxy compound/oxetane compound), reported as a weight ratio, is typically within a range from 5/95 to 95/5, and is preferably from 10/90 to 50/50. If the amount of the oxetane compound is too small, then a deterioration in the flexibility of the cured product and a deterioration in the solvent resistance tend to occur, whereas in contrast, if the amount of the oxetane compound is too large, the likelihood of insufficient curing occurring in high humidity environments tends to increase.

Specific examples of the oxetane compound include 2-hydroxymethyl-2-rnethyloxetane, 2-hydroxymethyl-2-ethyloxetane, 2-hydroxymethyl-2-propyloxetane, 2-hydroxymethyl-2-butyloxetane, 1,4-bis{(3-ethyl-3-oxetanylmethoxy)methyl}benzene, 3-ethyl-3-(2-ethylhexyloxymethyl)oxetane, and di[1-ethyl(3-oxetanyl)]methyl ether. Further, commercially available oxetane compounds such as OXT-212 and OXT-221 (both product names, manufactured by Toagosei Co., Ltd.) may also be used.

Specific examples of the alicyclic epoxy compound include alicyclic epoxy resins such as 3,4-epoxycyclohexylmethyl-3′,4′-epoxycyclohexanecarboxylate, bis(3,4-epoxycyclohexylmethyl)adipate, vinylcyclohexene monoepoxide, ε-caprolactone-modified 3,4-epoxycyclohexylmethyl-3′,4′-epoxycyclohexanecarboxylate, and 1-methyl-4-(2-methyloxiranyl)-7-oxabicyclo[4.1.0]heptane. Further, commercially available alicyclic epoxy compounds may also be used, including Celloxide 2021, Celloxide 2021A, Celloxide 2021P, Celloxide 2080, Celloxide 2081, Celloxide 3000, Celloxide 2000, Epolead GT301, Epolead GT302, Epolead GT401, Epolead GT403, EHPE-3150 and EHPEL3150CE (all product names) manufactured by Daicel Chemical Industries, Ltd., and Cyracure UVR-6105, Cyracure UVR-6110, Cyracure UVR-6128, Cyracure UVR-6100, Cyracure UVR-6216 and Cyracure UVR-6000 (all product names) manufactured by The Dow Chemical Company.

More details relating to specific examples of the cationic polymerizable compounds are disclosed in Japanese Patent Laid-Open No. Hei 08 (1996)-143806, Japanese Patent Laid-Open No. Hei 08 (1996)-283320, Japanese Patent Laid-Open No. 2000-186079 and Japanese Patent Laid-Open No. 2000-327672 and the like, and the present invention may also be implemented by appropriately selection of one or more of the compounds exemplified within these publications. The compounds disclosed within these publications are incorporated herein by reference.

A cationic polymerization initiator is usually added to the cationic polymerizable resin composition. Examples of cationic polymerization initiators that may be used include sulfonium salts, iodonium salts, ammonium salts and phosphonium salts. Specific examples include aryl sulfonium salt derivatives (such as Cyracure UVI-6974, Cyracure UVI-6976, Cyracure UVI-6990 and Cyracure UVI-6992 manufactured by The Dow Chemical Company, and Adeka Optomer SP-150, Adeka Optomer SP-152, Adeka Optomer SP-170 and Adeka Optomer SP-172 manufactured by Adeka Corporation), aryl iodonium salt derivatives (such as RP-2074 manufactured by Rhodia Group), allene-ion complex derivatives, diazonium salt derivatives, triazine-based initiators, and other acid generators such as halides.

The amount used of the cationic polymerization initiator varies depending on factors such as the type of initiator used, the type and mass ratio of the cationic polymerizable compound used, and the usage conditions, but from a practical perspective, the amount of the cationic polymerization initiator is typically within a range from 0.1 to 10% by mass, and preferably from 1 to 6% by mass, relative to the total mass of the active energy beam-curable ink. If the amount of the cationic polymerization initiator is too large, then although the polymerization proceeds rapidly, the storage stability tends to deteriorate, whereas if the amount is too small, the curability deteriorates.

A solvent may be included within the active energy beam-curable ink, and examples of solvents that may be used include the same solvents as those listed above for the inkjet oil-based ink. The active energy beam-curable ink is printed using an inkjet recording method, and therefore from the viewpoint of the ink viscosity, the amount of the solvent is preferably limited so that the active energy beam-curable resin represents the main component of the ink. Preferably, the active energy beam-curable ink is a solventless type or may include an oil-based solvent of less than 35% by mass, and more preferably of less than 15% by mass relative to the total mass of the active energy beam-curable ink.

A polymerization inhibitor such as hydroquinone monomethyl ether or aluminum N-nitrosophenylhydroxylamine may also be added to the active energy beam-curable ink for the purpose of preventing gelling of the ink during storage. These polymerization inhibitors may be used individually, or two or more may be used in combination. An example of a commercially available polymerization inhibitor is the product Q-1301 manufactured by Wako Pure Chemical Industries, Ltd. The polymerization inhibitor is typically added in an amount within a range from 0.01 to 0.5% by mass relative to the total mass of the ink.

Further, in those cases where the active energy beam-curable ink is an ultraviolet-curable ink, an ultraviolet absorber may be added to the active energy beam-curable ink. Examples of the ultraviolet absorber include dibenzoylmethane derivatives (such as t-butyl rnethoxydibenzoylmethane), cinnamic acid derivatives (such as octyl methoxycinnamate), para-aminobenzoic acid derivatives (such as 2-ethylhexyl para-dimethylaminobenzoate), benzophenone-based compounds, triazine-based compounds, and carbon black. These ultraviolet absorbers may be used individually, or two or more may be used in combination. The ultraviolet absorber is typically added in an amount within a range from 0.01 to 0.5% by mass relative to the total mass of the ink.

Furthermore, in order to ensure excellent visibility of the ink image, the active energy beam-curable ink may be prepared without containing a colorant. A colorant such as a pigment or a dye may be added to the active energy beam-curable ink, but in order to ensure favorable visibility of the ink image, the colorant is preferably added in an amount that produces minimal coloration. Examples of colorants that may be used include the same colorants as those listed above for the inkjet oil-based ink.

Besides the components described above, the active energy beam-curable ink may also include suitable amounts of additive components such as antioxidants, antibacterial agents, moldproofing agents, polymerization inhibitors and pH modifiers.

The active energy beam-curable ink can be produced by mixing the above components using a dispersion device or high-speed mixer such as a beads mill, disper mixer, homomixer, colloid mill, ball mill, attritor or sand mill.

The refractive index of the active energy beam-curable ink prior to curing is preferably not less than 1.480, more preferably not less than 1.490, and most preferably 1.500 or higher. By coating the ink image with an active energy beam-curable ink having a refractive index prior to curing of 1.480 or greater, the image density of the ink image following curing of the active energy beam-curable ink can be improved. One method of ensuring that the refractive index for the entire active energy beam-curable ink prior to curing is not less than 1.480 involves using at least 20% by mass, relative to the total mass of the active energy beam-curable ink, of an active energy beam-curable resin having a refractive index prior to curing of not less than 1.500.

The viscosity of the active energy beam-curable ink may be altered as appropriate, but is preferably within a range from 50 to 100 mPa-s, more preferably from 50 to 85 mPa-s, and still more preferably from 50 to 70 mPa·s. This viscosity is measured at 25° C., by raising the shear stress from 0 Pa at a rate of 0.1 Pals, and refers to the ink viscosity at 10 Pa.

By ensuring that the viscosity of the active energy beam-curable ink is at least 50 mPa·s, penetration of the active energy beam-curable ink into the interior of a permeable substrate can be suppressed, and the ink that forms the ink image can be prevented from being drawn into the substrate interior together with the active energy beam-curable ink, meaning any deterioration in the image density can be prevented. Particularly in those cases where the ink image is formed using an oil-based ink, because the oil-based ink itself has a tendency to penetrate into the substrate interior, causing problems such as reduced image density and strike-through at the substrate underside, preventing the active energy beam-curable ink from penetrating into the substrate interior is very important.

Furthermore, by ensuring that the viscosity of the active energy beam-curable ink is not more than 100 mPa·s, the active energy beam-curable ink is able to be satisfactorily discharged from the inkjet head during inkjet recording.

Next is a description of the image formation method using the active energy beam-curable ink.

There are no particular restrictions on the method used for forming the ink image on the permeable substrate, and any of a variety of printing methods such as an inkjet recording method, stencil printing method or electrophotographic method may be used to form the ink image, using an ink suited to the printing method employed. There are no particular restrictions on the ink image formed, which may be a black and white or color image, and may have an arbitrary print coverage ratio, including solid images. For example, the image may comprise mainly characters such as a section of text, or may be a drawing or photograph having a comparatively high print coverage ratio.

The active energy beam-curable ink is applied using an inkjet recording method, and forms an image that corresponds with the ink image and is superimposed on top of the ink image. By using the active energy beam-curable ink to form an image that corresponds with the ink image and is superimposed on top of the ink image, the coating quantity of the active energy beam-curable ink can be reduced compared with the case where the active energy beam-curable ink is simply applied by solid printing across the entire surface of the substrate.

The image corresponding with the ink image is of a shape and size that corresponds with the shape and size of the ink image, and may either be the same size and shape as the ink image, or may be a larger image than the ink image that also includes the region surrounding the ink image. The image produced using the active energy beam-curable ink is formed as this image that corresponds with the ink image and is superimposed on top of the ink image, meaning the active energy beam-curable ink may either be applied in the region in which the ink image has been formed, or may be applied to a larger region that also includes the region surrounding the ink image. The superimposition of the active energy beam-curable ink on the ink image may exhibit a slight misalignment, provided it is within the margin of error.

In an inkjet recording method, printing can be performed on demand, and an image can be formed on the basis of image information in accordance with a request from a computer or the like. By subsequently applying the active energy beam-curable ink on the basis of the same image information as that used for forming the ink image, the active energy beam-curable ink can be printed as an image that corresponds with the ink image. The image information used when applying the active energy beam-curable ink may either be the same image information as that obtained from a computer or the like for the ink image, or may be obtained by using a scanner or the like to read the image information from the printed ink image.

The inkjet printing apparatus used for conducting the printing of the active energy beam-curable ink may employ any of various printing systems, including a thermal system, a piezo system or an electrostatic system. The inkjet printing apparatus discharges the active energy beam-curable ink from the nozzles within the inkjet head based on a digital signal, and adheres the discharged ink droplets to the permeable substrate such as a sheet of paper. Subsequently, an active energy beam is irradiated onto the printed surface to cure the coating of the active energy beam-curable ink.

There are no particular restrictions on the active energy beam used for conducting the curing, and examples include electromagnetic radiation such as ultraviolet radiation, X-rays or γ-rays. Of the various possibilities, for reasons including the wavelength absorption properties of the polymerization initiator, the resins used, and the general availability of the irradiation apparatus, an ultraviolet-curable ink (UV ink) is preferred. In such cases, examples of preferred light sources include a high-pressure mercury lamp, metal halide lamp, xenon lamp or ultraviolet LED. Further, in those cases where the active energy beam is irradiated using an inkjet printing apparatus, irradiation of ultraviolet light can be performed immediately following printing by using an optical fiber-based light source such as an Optical Modulex manufactured by Ushio Inc., and installing this optical fiber next to the inkjet head so that the light source can move in tandem with the movement of the head.

The mass of droplets per unit of surface area of the active energy beam-curable ink relative to the total mass of droplets per unit of surface area of the ink used in forming the ink image is preferably not less than 70% by mass and not more than 500% by mass, and the combined volume of droplets per unit of surface area of the active energy beam-curable ink and droplets per unit of surface area of the ink used in forming the ink image is preferably not more than 1.50 μl/cm². Here, the expression “the total mass of droplets per unit of surface area of the ink used in forming the ink image” refers to the mass of droplets of a single ink in those cases where the ink image is formed using a single colored ink, or refers to the combined mass of droplets of a plurality of inks in those cases where the ink image is formed using inks of a plurality of colors.

The mass of droplets per unit of surface area of the active energy beam-curable ink relative to the total mass of droplets per unit of surface area of the ink used in forming the ink image is more preferably not less than 70% by mass and not more than 300% by mass, and is most preferably not less than 70% by mass and not more than 120% by mass. Moreover, the combined volume of droplets per unit of surface area of the active energy beam-curable ink and droplets per unit of surface area of the ink used in forming the ink image is more preferably not more than 1.25 μl/cm², and is most preferably 1.10 μl/cm² or less.

By ensuring that the mass of droplets per unit of surface area of the active energy beam-curable ink relative to the total mass of droplets per unit of surface area of the ink used in forming the ink image is not less than 70% by mass, the ink image can be favorably protected to ensure that satisfactory quick-drying properties and abrasion resistance are obtained for the ink image, and the image density of the ink image can also be enhanced. Furthermore, by ensuring that the mass of droplets per unit of surface area of the active energy beam-curable ink relative to the total mass of droplets per unit of surface area of the ink used in forming the ink image is not more than 500% by mass, the active energy beam-curable ink can be prevented from penetrating into the interior of the permeable substrate, thereby preventing show-through. Favorable flexibility can also be achieved for the printed item.

In addition, in those cases where the ink image is formed using an oil-based ink, the oil-based ink may penetrate into the substrate interior when applied to a permeable substrate, causing a reduction in the image density, and if the mass of droplets of the active energy beam-curable ink is increased, then the penetration into the substrate interior of the active energy beam-curable ink may occur and increase the amount of the oil-based ink that penetrates into the substrate interior, causing a further reduction in the image density. As a result, by restricting the mass of droplets of the active energy beam-curable ink relative to the total mass of droplets per unit of surface area of the ink used in forming the ink image to not more than 500% by mass, deterioration in the image density can be prevented, and strike-through to the underside of the substrate can also be prevented.

Furthermore, by ensuring that the combined volume of droplets per unit of surface area of the active energy beam-curable ink and droplets per unit of surface area of the ink used in forming the ink image is not more than 1.50 μl/cm², not only can the above effects be achieved, but image density reduction and strike-through can be more effectively prevented.

From the viewpoint of the quick-drying properties of the ink image, the time period from formation of the ink image until application of the active energy beam-curable ink is preferably kept short, and is preferably not more than 3 seconds and more preferably 1 second or less.

From the viewpoints of the quick-drying properties and the abrasion resistance of the active energy beam-curable ink, the time period from the application of the active energy beam-curable ink until curing of the ink is preferably kept short, and is preferably not more than 3 seconds and more preferably 1 second or less.

In those cases where the ink image is formed using an oil-based ink, the oil-based ink may penetrate into the substrate interior when applied to a permeable substrate, causing a reduction in the image density, but by curing the active energy beam-curable ink within a short period of time following application of the ink, penetration of the oil-based ink into the substrate interior can be suppressed, meaning any reduction in the image density can be prevented. Moreover, strike-through of the oil-based ink to the underside of the substrate can also be prevented.

In one preferred example of the printing mechanism used for forming the ink image and applying the active energy beam-curable ink, the ink image and the active energy beam-curable ink can be printed within the same line of a single inkjet printing apparatus. Specifically, in a line head inkjet printing apparatus, a first inkjet head for forming the ink image and a second inkjet head for applying the active energy beam-curable ink can be provided, with the second inkjet head positioned after the first inkjet head in terms of the direction of paper transport. Then, when the inkjet printing apparatus receives the image information and the command to start printing, the paper is transported into the printer, the ink image is formed first using the first inkjet head based on the image information, and the active energy beam-curable ink is then applied using the second inkjet head based on the same image information. Because the active energy beam-curable ink is applied based on the same image information as the ink image, the active energy beam-curable ink is applied in the region corresponding with the ink image and is superimposed on top of the ink image. In those cases where a color ink image is to be formed, a plurality of first inkjet heads may be provided.

In those cases where the inkjet head for the active energy beam-curable ink is not provided inside the inkjet printing apparatus, the ink image may be formed using a typical inkjet recording apparatus, the resulting printed item subsequently removed from the apparatus, and the active energy beam-curable ink then applied to the printed item using an inkjet printing apparatus capable of printing the active energy beam-curable ink.

Further, in those cases where the ink image is formed using a stencil printing method, an inkjet printing mechanism for applying the active energy beam-curable ink may be provided inside the stencil printing apparatus, so that the active energy beam-curable ink can be applied following the printing of the ink image by stencil printing. Further, in those cases where the inkjet printing mechanism is not provided inside the stencil printing apparatus, the ink image may be formed using a stencil printing apparatus, the resulting printed item subsequently removed from the apparatus, and the active energy beam-curable ink then applied to the printed item using an inkjet printing apparatus capable of printing the active energy beam-curable ink.

In those cases where the ink image is printed using another printing method, the image formation method of the present invention can be realized by using a printing apparatus with a similar mechanism to that described above.

### Examples

A more detailed description of the present invention is provided below based on a series of examples, although the present invention is in no way limited by these examples.

### 1. Method of Preparing UV Inks

The components listed in Table 1 were combined and then mixed thoroughly using a high-speed mixer, thus yielding UV inks (ultraviolet-curable inks) for a series of examples. The units for the components listed in the table are “mass %”. Details of the components listed in the table are presented in Table 2.

### <Method of Preparing Printed Items>

An inkjet recording apparatus HC5000 (manufactured by Riso Kagaku Corporation) was used as the printing apparatus. The HC5000 is a system that uses a 300 dpi line-type inkjet head (in which the nozzles are aligned with an approximately 85 μM spacing therebetween), wherein the paper is transported in a sub-scanning direction perpendicular to the main scanning direction (the direction along which the nozzles are aligned) while printing is conducted.

HC ink black (an inkjet oil-based ink with a black pigment, manufactured by Riso Kagaku Corporation) was used as the oil-based ink for the ink image. A high-quality paper (Riso lightweight paper, manufactured by Riso Kagaku Corporation) was used as the printing paper.

Of the inkjet heads within the HC5000, the oil-based ink was loaded into the inkjet head on the upstream side in the paper transport direction, and a UV ink was loaded into the inkjet head on the downstream side in the paper transport direction. Using the HC5000, printing was conducted on the basis of image information, by transporting the paper into the apparatus, firstly printing the ink image using the oil-based ink, and then printing the image using the UV ink. The image information represented a solid image of a specific surface area equivalent to 300 dpi×300 dpi, wherein the amount of ink droplets per unit of surface area was able to be altered by changing the droplet amount discharged from each nozzle within the head, meaning an image having a desired ink droplet amount could be obtained.

Because the oil-based ink and the UV ink were printed based on the same image information, the UV ink was applied in the region corresponding with the ink image of the oil-based ink and was superimposed on top of the ink image. Following printing, ultraviolet light was irradiated onto the printed image using a metal halide lamp (manufactured by Fusion UV Systems Japan K.K., peak wavelength: 365 nm), thus forming a printed item for each of the examples.

As a comparative example, processing was conducted to prepare a printed item in the same manner as each of the examples, with the exception of not applying the UV ink and performing subsequent curing. In other words, in the printed item of the comparative example, an image was formed using only the oil-based ink, and no UV ink treatment was performed.

### 2. Evaluations

The evaluations described below were performed for each of the examples and the comparative example. The results of the evaluations are also included in Table 1.

### <Method of Calculating Droplet Volume of Oil-Based Ink and UV Ink>

Using the oil-based ink and each of the UV inks, printing of a solid image of a specific surface area equivalent to 300 dpi×300 dpi was conducted onto a PET film, and the mass of droplets per unit of surface area was calculated for the oil-based ink and the UV ink based on the change in mass of the PET film measured before and after printing. Based on the calculated amount of droplets, the ratio of the mass of droplets of the UV ink relative to the mass of droplets within the ink image [mass of droplets of UV ink/mass of droplets of oil-based ink (mass %)], and the combined volume of droplets of the UV ink and droplets of the oil-based ink [volume of droplets of UV ink+volume of droplets of oil-based ink (μl/cm²)] were determined.

### <UV Ink Viscosity>

The UV ink viscosity represents the viscosity at 10 Pa when the shear stress was raised from 0 Pa at a rate of 0.1 Pa/s at a temperature of 25° C., and was measured using a controlled stress rheometer RS75 manufactured by Haake GmbH (cone angle: 1°, diameter: 60 mm).

### <Refractive Index of UV Ink Prior to Curing>

The refractive index of the UV ink prior to curing was measured using a hand-held refractometer R-5000 manufactured by Atago Co., Ltd.

### <Image Density of Printed Item>

The OD value of the printed surface (upper surface) of the printed item was measured using a Macbeth reflective densitometer RD920, manufactured by Kollmorgen Corporation, and was then evaluated against the criteria below.

A: 1.4 or greater

B: at least 1.2 but less than 1.4

C: less than 1.2

### <Printed Item Strike-Through>

The underside of the printed item was inspected visually, and evaluated against the criteria below.

A: no noticeable strike-through

B: some strike-through, but minor

C: noticeable strike-through

### <Abrasion Resistance>

Using a crockmeter (manufactured by Toyo Seiki Seisaku-sho, Ltd.), a gauze was attached to the friction element, which was then rubbed 20 times back and forth across the printed surface. The printed surface was then inspected and evaluated against the criteria below.

A: absolutely no scratches

B: some partial scratching

C: the printed surface peeled easily

TABLE 1
UV ink components and evaluation results

| | Component | | | | | | | |
|---|---|---|---|---|---|---|---|---|
| (Mass %) | number | Example 1 | Example 2 | Example 3 | Example 4 | Example 5 | Example 6 | Example 7 |
| Reactive | M-140 | — | — | — | — | — | — | — |
| diluent | FA-512A | — | — | — | — | — | — | — |
| solvent | M-203S | — | — | — | — | — | — | 25.00 |
| | M-215 | — | — | — | — | — | 25.00 | — |
| | Ogsol | 20.00 | 20.00 | — | — | — | — | — |
| | EA-0500 | | | | | | | |
| | Ogsol | — | — | 25.00 | — | — | — | — |
| | EA-F5003 | | | | | | | |
| | 1,9-NDA | 74.95 | 74.95 | 69.95 | 64.95 | 74.95 | 69.95 | 69.95 |
| Oligomer | M-6250 | — | — | — | 30.00 | — | — | — |
| | M-7100 | — | — | — | — | 20.00 | — | — |
| Polymerization | Q-1301 | 0.05 | 0.05 | 0.05 | 0.05 | 0.05 | 0.05 | 0.05 |
| inhibitor | | | | | | | | |
| Polymerization | Irg.369 | 5.00 | 5.00 | 5.00 | 5.00 | 5.00 | 5.00 | 5.00 |
| initiator | | | | | | | | |

| | | | | | | | |
|---|---|---|---|---|---|---|---|
| Total | 100.00 | 100.00 | 100.00 | 100.00 | 100.00 | 100.00 | 100.00 |
| Evaluation item | | | | | | | |
| Mass of droplets of UV ink/ | 100 | 100 | 80 | 60 | 500 | 600 | 100 |
| mass of droplets of oil-based | | | | | | | |
| ink (mass %) | | | | | | | |
| Volume of droplets of UV | 1.62 | 1.08 | 0.97 | 0.86 | 0.64 | 0.66 | 1.08 |
| ink + volume of droplets of | | | | | | | |
| oil-based ink (μl/cm²) | | | | | | | |
| UV ink viscosity (mPa · s) | 70.00 | 70.00 | 65.00 | 60.00 | 70.00 | 65.00 | 50.00 |
| Refractive index of UV ink | 1.488 | 1.488 | 1.491 | 1.488 | 1.480 | 1.485 | 1.483 |
| prior to curing | | | | | | | |
| Image density | A | A | A | A | A | A | A |
| Strike-through | C | A | A | A | A | C | A |
| Abrasion resistance | A | A | A | B | A | A | A |

| | Component | | | Example | Example | Comparative |
|---|---|---|---|---|---|---|
| (Mass %) | number | Example 8 | Example 9 | 10 | 11 | example 1 |
| Reactive | M-140 | — | 20.00 | — | — | — |
| diluent | FA-512A | 20.00 | — | — | 94.95 | — |
| solvent | M-203S | 30.00 | — | — | — | — |
| | M-215 | — | — | — | — | — |
| | Ogsol | — | — | — | — | — |
| | EA-0500 | | | | | |
| | Ogsol | — | — | — | — | — |
| | EA-F5003 | | | | | |
| | 1,9-NDA | 44.95 | 64.95 | 84.95 | — | — |
| Oligomer | M-6250 | — | 10.00 | 10.00 | — | — |
| | M-7100 | — | — | — | — | — |
| Polymerization | Q-1301 | 0.05 | 0.05 | 0.05 | 0.05 | — |
| inhibitor | | | | | | |
| Polymerization | Irg.369 | 5.00 | 5.00 | 5.00 | 5.00 | — |
| initiator | | | | | | |

| | | | | | |
|---|---|---|---|---|---|
| Total | 100.00 | 100.00 | 100.00 | 100.00 | — |
| Evaluation item | | | | | |
| Mass of droplets of UV ink/ | 100 | 100 | 100 | 100 | — |
| mass of droplets of oil-based | | | | | |
| ink (mass %) | | | | | |
| Volume of droplets of UV | 1.08 | 1.08 | 1.08 | 1.08 | — |
| ink + volume of droplets of | | | | | |
| oil-based ink (μl/cm²) | | | | | |
| UV ink viscosity (mPa · s) | 50.00 | 60.00 | 35.00 | 30.00 | — |
| Refractive index of UV ink | 1.480 | 1.483 | 1.477 | 1.500 | — |
| prior to curing | | | | | |
| Image density | A | A | B | A | C |
| Strike-through | A | A | B | B | C |
| Abrasion resistance | A | A | A | A | C |

TABLE 2
Details of UV ink components

| | Component | | |
|---|---|---|---|
| | number | Details | Manufacturer |
| Reactive diluent solvent | M-140 | N-acryloyloxyethyl hexahydrophthalimide | Toagosei Co., Ltd. |
| | FA-512A | Dicyclopentenyloxyethyl acrylate | Hitachi Chemical Co., Ltd. |
| | M-203S | Dimethyloldicyclopentane diacrylate | Toagosei Co., Ltd. |
| | M-215 | Isocyanuric acid EO-modified diacrylate | Toagosei Co., Ltd. |
| | Ogsol EA-0500 | Fluorene diacrylate | Osaka Gas Co., Ltd. |
| | Ogsol EA-F5003 | Fluorene diacrylate | Osaka Gas Co., Ltd. |
| | 1,9-NDA | 1,9-nonanediol diacrylate | Kyoeisha Chemical Co., Ltd. |
| Oligomer | M-6250 | Polyester acrylate | Toagosei Co., Ltd. |
| | M-7100 | Polyester acrylate | Toagosei Co., Ltd. |
| Polymerization inhibitor | Q-1301 | | Wako Pure Chemical Industries, Ltd. |
| Polymerization initiator | Irg.369 | | Ciba Japan K.K. |

As detailed in Table 1, in each of the examples, by coating the ink image with a UV ink, a higher image density, better prevention of strike-through, and superior abrasion resistance were obtained compared with the comparative example. In examples 2, 3, 5 and 7 to 11, the amount of ink droplets of the UV ink was particularly appropriate, which enabled strike-through and abrasion to be even more effectively prevented. In example 1, the amount of droplets of the UV ink was somewhat large, and both strike-through and show-through of the UV ink was confirmed, although the image density and abrasion resistance results were favorable, and the formulation was practically applicable depending on the actual application. In examples 1 to 9, the viscosity of the UV ink was particularly appropriate, which enabled strike-through to be prevented even more effectively. In examples 1 to 9 and example 11, the refractive index of the UV ink prior to curing was particularly appropriate, which enabled the image density to be further increased.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An image formation method comprising: using an inkjet recording method and an active energy beam-curable ink to form, on a permeable substrate having an ink image formed thereon, an image that corresponds with the ink image and is superimposed on top of the ink image.

2. The image formation method according to claim 1, wherein
a mass of droplets per unit of surface area of the active energy beam-curable ink relative to a total mass of droplets per unit of surface area of an ink used in forming the ink image is not less than 70% by mass and not more than 500% by mass, and
a combined volume of droplets per unit of surface area of the active energy beam-curable ink and droplets per unit of surface area of the ink used in forming the ink image is not more than 1.50 μl/cm².

3. An active energy beam-curable ink that can be used in the image formation method according to claim 1, wherein a refractive index of the ink prior to curing is not less than 1.480.

4. An active energy beam-curable ink that can be used in the image formation method according to claim 2, wherein a refractive index of the ink prior to curing is not less than 1.480.

5. The image formation method according to claim 1, wherein the ink image is formed using an oil-based ink.

6. The image formation method according to claim 2, wherein the ink image is formed using an oil-based ink.

7. The image formation method according to claim 1, wherein the active energy beam-curable ink comprises an active energy beam-curable resin within a range from 60 to 95% by mass.

8. The image formation method according to claim 2, wherein the active energy beam-curable ink comprises an active energy beam-curable resin within a range from 60 to 95% by mass.

9. The image formation method according to claim 1, wherein a refractive index of the active energy beam-curable ink prior to curing is not less than 1.480.

10. The image formation method according to claim 2, wherein a refractive index of the active energy beam-curable ink prior to curing is not less than 1.480.
